(19) United States
(12) Patent Application Publication
(10) Pub. No.: US 2010/0205674 A1
(43) Pub. Date: Aug. 12, 2010

(54) Monitoring System for Heap Spraying Attacks

(75) Inventors: Benjamin G. Zorn, Woodinville, WA (US); Benjamin Livshits, Kirkland, WA (US); Paruj Ratanaworabhan, Austin, TX (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/369,018

(22) Filed: Feb. 11, 2009

(51) Int. Cl. G06F 21/00

(52) U.S. Cl. 726/25

(57) ABSTRACT

A monitoring system may analyze system memory to determine a vulnerability statistic by identifying potential sleds within the memory, and creating a statistic that is a ratio of the amount of potential sleds per the total memory. In some cases, the statistic may be based on the number of instructions or bytes consumed by the sleds. The potential sleds may be determined by several different mechanisms, including abstract payload execution, polymorphic sled detection, sled surface area calculation, and other mechanisms. The monitoring system may be a multi-threaded operation that continually monitors system memory and analyzes recently changed objects in memory. When the vulnerability statistic rises above a certain level, the system may alert a user or administrator to a high vulnerability condition.

### BACKGROUND

Many computer system attacks use two elements to compromise a computer system. The first part may be introduction of code that is placed in memory that either is malicious or directs a processor to malicious code. The second part is a mechanism for disrupting the execution mechanism to redirect execution to the malicious code, an example of such a mechanism may be a buffer overflow or stack overflow.

In a buffer overflow attack, the execution of a processor may be redirected to some place within the memory. Due to advances in operating system design such as address space randomization, the exact location within the memory of the malicious code is often not known. Attackers typically preppend a sequence of no operation (NOP) commands to the malicious code, so that processing may begin at any location within the NOP commands and proceed to the malicious code. The series of NOP commands is often referred to as a ‘sled’.

Many operating systems use a memory heap for program execution that may disperse objects among the heap in a random manner. In order for a buffer overflow attack to work, malicious attacks have morphed into heap spraying, where many different copies of malicious code, including sleds, are dropped into memory. In many heap spraying attacks, hundreds or thousands of sleds may be dispersed within the heap, raising the chances that a random jump into memory will land on a sled and redirect execution to the malicious code.

### SUMMARY

A monitoring system may analyze system memory to determine a vulnerability statistic by identifying potential sleds within the memory, and creating a statistic that is a ratio of the amount of potential sleds per the total memory. In some cases, the statistic may be based on the number of instructions or bytes consumed by the sleds. The potential sleds may be determined by several different mechanisms, including abstract payload execution, polymorphic sled detection, sled surface area calculation, and other mechanisms. The monitoring system may be a multi-threaded operation that continually monitors system memory and analyzes recently changed objects in memory. When the vulnerability statistic rises above a certain level, the system may alert a user or administrator to a high vulnerability condition.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with a memory manager.

FIG. 2 is a diagram illustration of an embodiment showing a heap spraying example.

FIG. 3 is a flowchart illustration of an embodiment showing a general method for analyzing and monitoring memory.

FIG. 4 is a flowchart illustration of an embodiment showing a method for calculating sled surface area for memory objects.

FIG. 5 is a diagram illustration of an embodiment showing an architecture for implementing memory analysis.

### DETAILED DESCRIPTION

The vulnerability of a bulk memory may be analyzed by identifying potential sleds of NOP operators and generating a statistic that relates the number of potential sleds to the amount of memory. When the statistic reaches a predetermined limit, a warning or other alert may be issued.

The memory analysis may be performed on random access memory that is available to a computer processor, as well as data that may be loaded into random access memory. Some embodiments may include a monitoring system for identifying objects in memory that have been added or changed, so that an analysis may be performed on those objects.

One mechanism to determine a vulnerability statistic is to calculate a ‘surface area’ of potential sleds. The sleds may be found in any type of information in a memory area, including data and executable information. The surface area may be calculated by creating a control flow graph and analyzing the blocks with the graph to determine if the blocks could be executed as if the blocks were NOP operators or operators that functioned like NOP operators.

For the purposes of this specification and claims, references to NOP commands may be any command that may be executed that has an effect of a NOP command for the purposes of a sled. The sleds may be any sequence of executable instructions that operate as a NOP or no operation instruction. The sequence of executable instructions may perform many different functions, but may operate as NOP commands when the instructions do not halt the processor, use a kernel mode to operate, or reference an address outside the range of the process memory.

In some sleds, the NOP instructions may be considered any instructions other than system calls, I/O calls, interrupts, privileged instructions, or jumps outside of the current process address space. For example, an instruction that performs a summation of two registers may be considered a NOP instruction for the purposes of a sled. System calls, interrupts, and other calls may cause the execution of the processor to revert back to other methods and may defeat the operation of the sled.

Throughout this specification, like reference numbers signify the same elements throughout the description of the figures.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

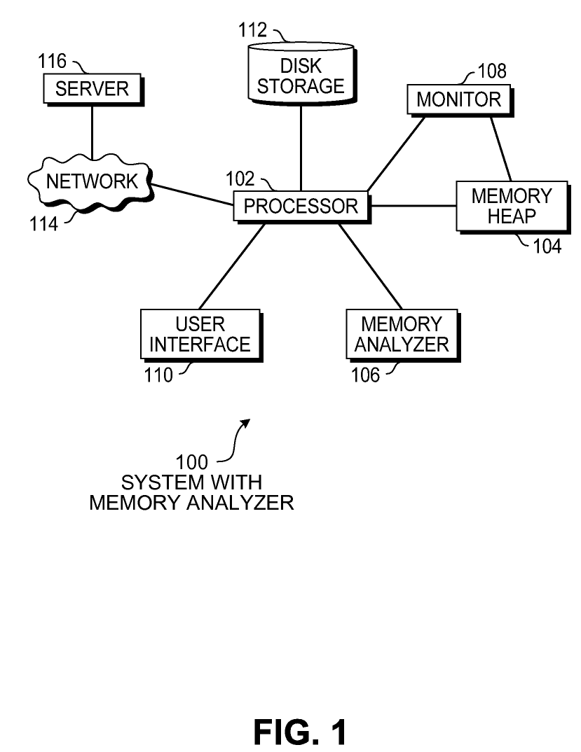

FIG. 1 is a diagram of an embodiment 100 showing a system that may analyze a memory location to determine if the contents of the memory are vulnerable to a misdirected execution. Embodiment 100 is a simplified example of a device, such as a personal computer or server computer, that may implement such a memory monitoring and analysis mechanism.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

The system of embodiment 100 may manage various memory locations to determine an estimation for vulnerability of the memory. The vulnerability may be for various redirection types of attacks.

In a redirection type of attack, an execution buffer, stack, or table may be corrupted to redirect a processor execution to a location in which malicious code may be placed. Common forms of such attacks include heap overflow attacks, stack buffer exploitation, heap spraying attacks, and other attacks.

In a stack buffer overflow situation, the executing stack may be corrupted to point to a different address than intended. The different address may cause the execution to jump to a location within the memory. In order to increase the target area of the redirection, a NOP sled maybe used to increase the target area for receiving a jump. The NOP sled may comprise operations that, if executed, serve to move the execution to a point where dangerous or malicious code may be located.

In some operating systems, memory in a heap may be dynamically allocated at application runtime. As such, an attacker may not know where to point a stack buffer, virtual function table, or other execution pointer. A technique of heap spraying is a technique where large numbers of objects are dispersed across the memory. The objects may have NOP sleds and may serve to catch a random pointer and redirect execution to a malicious code segment.

Embodiment 100 illustrates the functional components of a system that may perform memory analysis and monitoring. Embodiment 100 may represent many different types of devices that use a processor 102 for executing instructions that may be in a memory heap 104. A memory analyzer 106 may examine various memory devices, including the memory heap 104 to determine a vulnerability statistic for the memory.

Some embodiments may have a monitor 108 that may detect when changes occur in the memory heap 104 and launch the memory analyzer 106 to examine the changed portions of the memory heap 104.

Some embodiments may have a user interface 110 through which alerts or status of the analyzed memory may be displayed, and through which a user may cause the memory analyzer 106 and monitor 108 to launch their respective functions.

In many embodiments, the memory analyzer 106 may be used to analyze and monitor a memory heap 104. The memory heap 104 may be random access memory in which executable instructions and/or data may be stored, and many different forms of such memory may be used with different types and configurations of processors 102.

In some embodiments, the memory analyzer 106 may be used to analyze raw data that may be stored in a memory heap 104 on the current device or on another device. For example, the memory analyzer 106 may be used to scan a data file such as an image file, database file, audio or video media file, or any other type of data file. An innocuous data file, such as a data file containing an otherwise harmless image, may be embedded with malicious code and one or more NOP sleds and may contain malicious code or links to malicious code. When the image file is loaded into the memory heap 104, the image file may be used to catch a random jump from a buffer or virtual function table overflow or other corruption.

Such embodiments may have a memory analyzer 106 that may be capable of analyzing files in a disk storage system 112. A file may be analyzed while the file is stored on the disk storage system 112 prior to loading the file into memory. Such embodiments may perform analysis when the file is requested to be loaded into memory, for example, to ensure that the file does not pose a threat to the overall system.

Some such embodiments may have a memory analyzer 106 that is capable of analyzing data that is received over a network 114 from a server 116. The data received from the server 116 may be any type of data, such as streaming data, data files, or other information. An example of the data received from a server 116 may be data retrieved by a web browser from a web server. The downloaded data may be analyzed by the memory analyzer 106 prior to loading the data into the memory heap 104. In other embodiments, the data may be loaded into the memory heap 104 and the monitor 108 may cause the memory analyzer 106 to scan the newly added data.

Embodiment 100 may represent any device that has at least one processor 102 and a memory heap 104. Embodiments may include personal computers, server computers, and other network attached devices. Other embodiments may include handheld or portable devices such as laptop computers, personal digital assistants, cellular telephones, portable scanning devices, portable media players, or other devices.

In some embodiments, the device may be a peripheral device that has an independent processor from a main computer device. Examples may include printer or scanner devices, devices attached by a Universal Serial Bus, or other devices that may include a processor and memory heap.

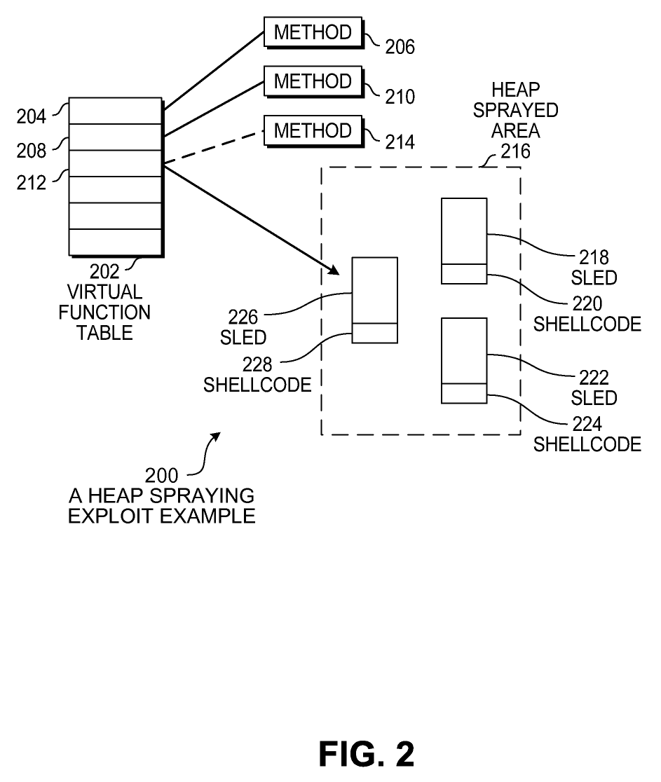

FIG. 2 is a diagram of an embodiment 200 showing a system that may be vulnerable to a heap spraying exploit. Embodiment 200 is a simplified example of the components that may be affected by a heap spraying exploit, and illustrate the sleds and shellcode that may be dispersed within a memory heap.

In a heap spraying exploit, a virtual function table 202 may be corrupted, changed, or otherwise modified to point to a location within a memory heap. The memory heap may be populated by many sleds that may capture the virtual function table pointer and redirect the pointer to malicious shellcode. The shellcode may be malicious or may further redirect the execution to another malicious code.

Other exploits, such as buffer overflow exploits, operate in a similar manner, where a processor execution may be redirected from an intended set of instructions to a sled and associated shellcode.

Embodiment 200 illustrates a virtual function table 202. Virtual function tables may be referred to as virtual method tables, dispatch table, vtable, or other terms. In many embodiments, a virtual function table 202 may enable runtime method binding. In practice, virtual function table 202 could be any object in heap that may contain a function pointer that the attacker is able to overwrite.

In the virtual function table 202, entry 204 may point to a method 206. Similarly, entry 208 may point to a method 210. Entry 212 may have been created to point to method 214, but the entry 212 may be corrupted to point to a random location within the memory heap.

When the pointer in entry 212 is redirected into a heap sprayed area 216, a large number of sleds with associated shellcode may be present. If the pointer in entry 212 points to one of the sleds, the execution may be directed to the shellcode which may be malicious code.

In a heap spraying attack, many copies of a sled and shellcode may be placed in memory. Often, hundreds or thousands of copies of a sled and shellcode may be present. In some cases, the sled and shellcode may be placed in memory by a script that may be executed by a web browser. In another example, the sled and shellcode may be placed in memory through a data file that is loaded into memory, such as an image file, text file, or an otherwise innocuous file.

Embodiment 200 illustrates sled 218 with shellcode 220, sled 222 with shellcode 224, and sled 226 with shellcode 228.

The sleds may be any sequence of executable instructions that operate as a NOP or no operation instruction. In some sleds, the NOP instructions may be considered any instructions other than system calls, I/O calls, interrupts, privileged instructions, or jumps outside of the current process address space. For example, an instruction that performs a summation of two registers may be considered a NOP instruction for the purposes of a sled. System calls, interrupts, and other calls may cause the execution of the processor to revert back to other methods and may defeat the operation of the sled.

When many sleds are present, a memory location may be vulnerable to a misdirected execution pointer, such as a corrupted execution stack or virtual function table. In order for a heap spraying attack to be successful, a large amount of the memory heap may contain sleds, as each redirection of an execution pointer may be a random jump into the memory heap. The likelihood of success is proportional to the combined size of the sleds present in the memory. By examining objects in the memory heap as if those objects were sleds, an effective measure of the vulnerability of the memory heap may be taken.

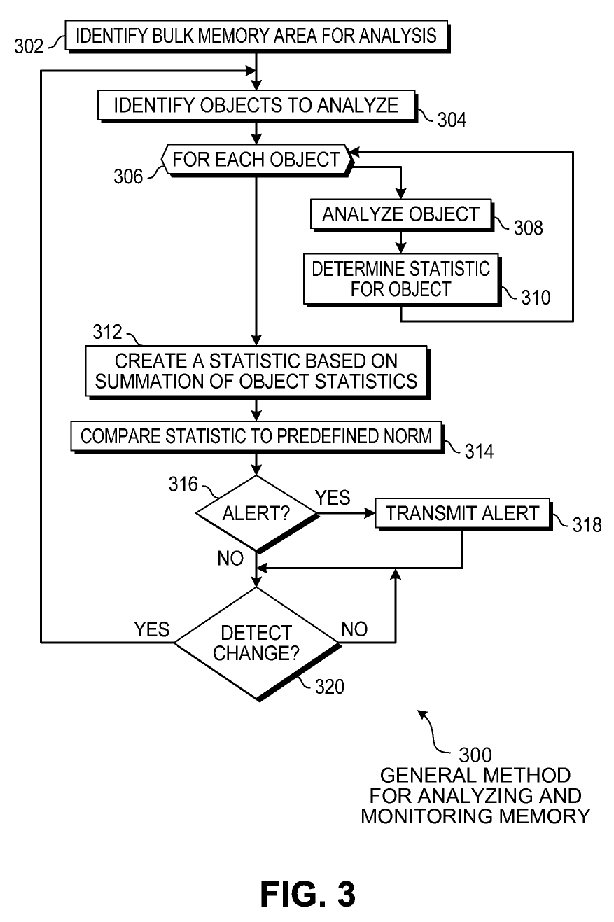

FIG. 3 is a flowchart illustration of an embodiment 300 showing a method for analyzing and monitoring memory. Embodiment 300 is a simplified example of merely one method that may analyze and monitor active memory, such as a memory heap, in a device described in embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of a high level sequence for analyzing and monitoring memory and for determining a vulnerability statistic for the memory. Embodiment 300 analyzes individual objects that are stored in memory and determines a statistic for those objects. The statistics for all of the analyzed objects are summed and compared to a predetermined value. If the overall statistic is greater than the predetermined value, an alert may be transmitted.

Embodiment 300 may be performed on a subset of the objects in memory. For example, a sampling of objects may be analyzed and an overall vulnerability statistic may be extrapolated for the entire memory area. In some cases, such a sampling may yield similar results to a full analysis of the memory area without the associated processing time.

A monitoring system may be used in embodiment 300 to identify newly added, removed, or newly changed objects in memory. The monitoring system may cause newly added objects to be analyzed and the results added to the overall statistics. For an object that is removed, overall statistics may be recalculated without the object that is removed.

In block 302, the bulk memory area may be identified for analysis. Many embodiments may analyze a memory heap in full, while other embodiments may sample objects in a memory heap. In some experiments, accurate results may be achieved by sampling merely 5-10% of the available objects.

Some embodiments may perform the method of embodiment 300 as a background process. As such, the method of embodiment 300 may be performed on segments of the memory heap when a processor is not busy performing other tasks. In such embodiments, the method of embodiment 300 may be performed several times until the entire memory heap may be analyzed, with each pass being performed on a different section of bulk memory in block 302. For example, the embodiment 300 may be run on individual pages of memory.

Some embodiments may perform an analysis on a static memory location, such as a file that may be stored on a disk drive, a USB flash drive, or some other memory location. Such analyses may be performed to determine if a file may pose a risk when the file is loaded into an active memory heap. In other embodiments, data that are downloaded from a remote location, such as data retrieved by a web browser, may be analyzed prior to or just after placing the data in memory.

In block 304, objects within the bulk memory area may be identified for analysis. The objects identified in block 304 may be those objects that have been recently changed, objects that have been selected as part of a sampling mechanism, or objects selected using other criteria.

The objects in block 304 may be any portion of memory. In some embodiments, the objects may be executable objects, such as methods, as well as various data structures stored in memory. The objects may be tracked and managed by a memory management system that may perform other functions, such as memory allocation and garbage collection.

In some embodiments, the objects in block 304 may be portions of memory. For example, the objects may be a memory page or block. The pages or blocks of memory may be analyzed without regard to whether the pages or blocks contain specific types of objects.

For each object in block 306, the object may be analyzed in block 308 and at least one statistic for the object may be determined in block 310.

One embodiment of the analysis of block 308 and the statistic determination of block 310 is illustrated in embodiment 400 described later in this specification. Embodiment 400 is an example of a vulnerability statistic that is based on the surface area of a potential sled, which may be calculated from a control flow diagram of the object.

Other embodiments may use various methods to analyze the objects individually. Some embodiments may use pattern recognition to identify sleds within an object. A pattern recognition technique may search a sled to find signatures of NOP instructions and generate a statistic based on the frequency or size of the signatures. In such cases, the signatures may be known signatures from previous attacks.

Another technique may involve searching for long series of NOP instructions within a stream or sequence of bytes that define an object. Such a technique may be useful in identifying some sleds, but may miss sleds that include one or more jump operations that can redirect execution to another memory location within the sled.

Some analysis techniques may involve following various branches within a sled to calculate a maximum executable length of a sled. The longer the maximum executable length, the more likely a sled may capture a random jump into the memory area.

The analysis of objects in block 308 may find potential sleds as opposed to sleds that pose an actual threat. In many cases, the analysis in block 308 may not evaluate the related shellcode to determine if the sled is actually a threat. Analysis of the shellcode may be quite complex, but identifying the sleds may be performed quickly and may give an approximate evaluation of the vulnerability. A vulnerability statistic may equate to a likelihood determination that a jump to a location may result in executing malicious or damaging code.

Some embodiments may perform an analysis that includes an analysis of the potential vulnerability of the shellcode. If the shellcode is determined to be benign, the object may be considered safe. If the shellcode is determined to be dangerous, the object may be considered dangerous.

A statistic may be created in block 312 that is based on the summation of statistics gathered for the analyzed objects in block 310. In many cases, the statistic may be normalized across the total memory location.

For example, a memory heap may have 100 objects in 1 megabyte of memory, and each of the objects may be analyzed. The average potential sled length may be calculated to be 100 bytes long per object. Thus, the total memory allocated to potential sleds may be 100 bytes times 100 objects or 10,000 bytes. The normalized statistic may be 10,000 bytes of potential sleds divided by 1,000,000 bytes of memory size or a normalized statistic of 0.01 vulnerability.

In empirical tests, a similarly calculated vulnerability less than a range of 0.10 to 0.30 may be considered safe. Vulnerability calculated at 0.5 or higher may indicate a large presence of sleds and that a device is under attack or is vulnerable to attack.

The statistic may be compared to a predefined norm in block 314. If an alert is to be generated based on the comparison in block 316, the alert may be created and transmitted in block 318.

In the previous example of a vulnerability statistic of 0.01, a predefined norm of 0.15 or 0.5 may be used to compare the vulnerability statistic to determine if an alert may be generated. Other embodiments may use different statistics for which a predefined norm may be used in block 314.

In some embodiments, a dynamically defined norm may be used. For example, a security alert may be issued to a device that may be increase or decrease the norm.

In another example of a dynamically defined norm, an exponentially weighted moving average of a statistic may be used as a baseline value, along with standard deviations or other metrics. When the statistic calculated in block 312, the newly calculated statistic may be compared to the previously calculated average to determine if the newly calculated statistic is sufficiently different to warrant an alert in block 316. For example, if a newly calculated statistic changes more than two standard deviations from the previous average, an alert may be generated in block 316.

The alert of block 318 may be any type of action that may be taken based on a high vulnerability. In the case of a memory heap analysis, the high vulnerability may cause a message to be presented to a user or system administrator. In some cases, an anti-virus or anti-malware scan may be initiated for the device. Some embodiments may cause the device to be shut down or operated in a safe mode, for example. In embodiments where a file on a disk drive is being analyzed, the alert of block 318 may tag the file for a high vulnerability, for example.

In block 320, if a change is detected, the process may return to block 304 for further analysis. Block 320 may represent a monitoring system that may detect changes to objects in memory, which may include objects that are added, removed, or updated. Newly added objects or objects that are changed may be analyzed and the overall statistic for the memory location may be updated. Objects that are removed may also cause the overall statistic to be updated.

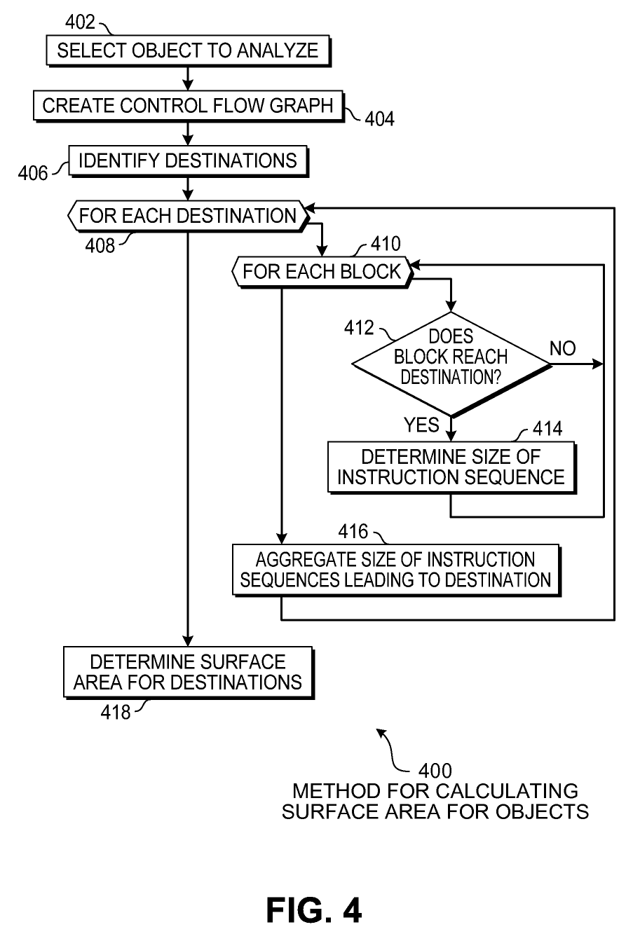

FIG. 4 is a flowchart illustration of an embodiment 400 showing a method for analyzing and monitoring a memory object. Embodiment 400 is a simplified example of merely one method that may analyze and monitor active memory to create a surface area for a potential sled in the object. Embodiment 400 is an example of a process that may be performed in blocks 308 and 310 of embodiment 300.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is a simplified example of a method to create a surface area calculation for a memory object. A control flow graph is created and the branches of the control flow graph are evaluated to determine an overall surface area of the object for a particular destination. The destination may be assumed to be shellcode or other malicious code.

Embodiment 400 treats a memory object as executable code, regardless if the object is loaded into memory as executable code. In many cases, the object may be a data object, such as an array, string, visual image, or other data object stored in memory.

The object to be analyzed may be selected in block 402 and a control flow graph may be created for the object in block 404.

The control flow graph in block 404 may organize the commands within the object in blocks of executable commands. The blocks may have jumps at the end of a block and jump targets that begin the blocks. In some cases, conditional commands may cause branches between the blocks.

From the control flow graph in block 404, various destinations may be identified in block 406. The destinations may be an address or location from a jump at the end of a block. One method for identifying a destination is to identify a postdominator block within the control flow graph as a destination.

In some embodiments, the destinations in block 406 may be any possible destination within the object. In some cases, a single destination may be determined from the object. Multiple destinations may be present in some cases, especially where a block or page of memory is analyzed. When multiple destinations are present, each destination may be considered malicious for the purposes of analysis. Effective heap spraying attacks tend to have destinations with very large surface areas compared to other destinations. Thus, some embodiments may select the destination with the highest surface area as a metric representing the analyzed object.

For each destination in block 408, each block may be analyzed in block 410. The block being analyzed may be evaluated in block 412 to determine if the block reaches the given destination through a series of NOP operations.

In block 412, the NOP operations may be assigned to any executable command other than system calls, I/O calls, interrupts, privileged instructions, or jumps outside the address space. Some embodiments may have different definitions for NOP commands, and such definitions may be different for different processor or device architectures.

If the block reaches the destination in block 412, the size of instruction sequence may be determined in block 414. When an instruction size is determined in block 414, the number of instructions may be counted from the last non-NOP command to the jump point in the sequence of commands for the block. In some embodiments the size of an instruction sequence may be determined by the number of memory units, such as bytes, that are occupied by the instruction sequence.

After determining the length of instruction sequence in block 414, the process may return to block 410. If the block does not reach the destination in block 412, the process returns to block 410.

After each block is processed in block 410, the size of the instruction sequences that reach the destination are aggregated in block 416. After each destination is processed in block 408, a surface area for each destination is determined in block 418.

In many embodiments where actual sleds are evaluated, one or two destinations may have the largest surface area. In such cases, the surface area assigned to the object may be the destination with the largest surface area.

Embodiment 400 counts the number of instructions in a sequence of instructions to calculate a surface area. Other embodiments may use the number of memory units, such as bits, bytes, or words to calculate the size of the surface area. In such cases, the surface area may be expressed in memory units. Other embodiments may express the surface area in terms of number of instructions.

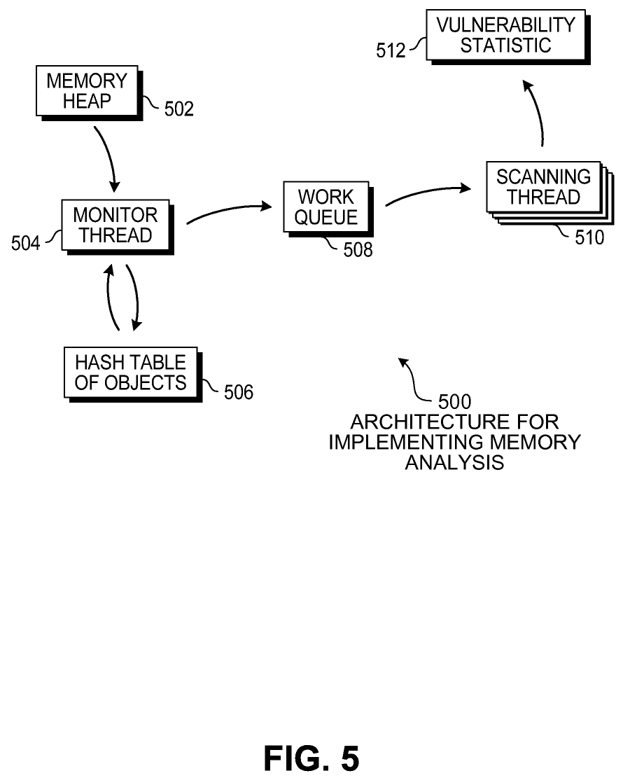

FIG. 5 is a diagram of an embodiment 500 showing an architecture that may be used for implementing memory analysis. Embodiment 500 is an example of a system that may implement the processes of embodiments 300 and 400.

Embodiment 500 is an example of a system that may be used in conjunction with an operating system for monitoring and managing a memory heap 502.

A monitoring thread 504 may intercept function calls that allocate and free memory. When memory is allocated or freed, a record in a hash table 506 may be updated to match the actual objects kept in the memory heap 502.

When an object is added or changed, the monitor thread 504 may update the hash table 506 and add the object to a work queue 508. Scanning threads 510 may pull an object from the work queue 508, perform a surface area calculation, and update the vulnerability statistic 512. In some embodiments, several scanning threads 510 may operate in parallel.

In many embodiments, only objects over a predetermined size may be placed in the work queue. In some such embodiments, objects less than 32, 64, or some other number of bytes may be excluded from scanning as those objects may not be considered large enough to contain shellcode.

In many embodiments, the monitoring thread 504 may select a sample of objects to place in the work queue 508. For example, the sampling may select objects that represent a fixed percentage of space in the memory heap 502.

One embodiment may use a similar configuration to manage one page of memory where a memory heap may comprise several pages. In such an embodiment, a single monitor thread 504 may monitor one memory page and the hash table 506 may comprise entries for objects in the local memory page only. A single scanning thread 510 may be assigned to process objects from the local memory page. In such an embodiment, each page of memory may have one monitor thread 504 and one scanning thread 510.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
identifying a bulk memory area for analysis;
analyzing objects within said bulk memory to determine a likelihood that said object is a sled for a malicious code by performing a simulated execution on said object;
creating a vulnerability statistic for said bulk memory area by comparing said likelihood for each of said objects to said bulk memory.

2. The method of claim 1, said vulnerability statistic comprising an aggregation of vulnerability of high likelihood objects normalized by said bulk memory area.

3. The method of claim 2, said vulnerability statistic comprising a sum of instructions for said high likelihood objects divided by a number of instructions for said bulk memory area.

4. The method of claim 2, said vulnerability statistic comprising a memory size consumed by said high likelihood objects divided by a memory size of said bulk memory area.

5. The method of claim 1, said analyzing objects being performed by a method comprising:
selecting a portion of memory being comprised in said object;
creating a control flow graph for said portion of memory to identify a first plurality of blocks of consecutive instructions, said first plurality of blocks being connected by control flow edges;
identifying a destination for said portion of memory from said control flow graph;
identifying a second plurality of said blocks that, if executed, connect to said destination;
for each of said second plurality of said blocks, identifying a length of instructions between said destination and a non-NOP command; and
aggregating said length of instructions to create a surface area metric for said destination.

6. The method of claim 1, said bulk memory area being a file.

7. The method of claim 1, said vulnerability statistic being generated by sampling said objects.

8. The method of claim 1 further comprising:
identifying a portion of said bulk memory area that has been updated but not analyzed, analyzing said objects within said portion of said bulk memory area, and updating said vulnerability statistic.

9. A system comprising:
a processor configured to execute instructions;
a random access memory configured to store executable code comprising said executable instructions, said random access memory being further configured to store data, said random access memory being accessible to said processor; and
a memory analyzer configured to analyze memory areas within said random access memory, determine a vulnerability factor for each of said memory areas, and create a vulnerability statistic for said random access memory based on said vulnerability factors.

10. The system of claim 9, said memory analyzer configured to operate on multiple threads on said processor.

11. The system of claim 9 further comprising:
a memory monitoring agent configured to identify a change within said random access memory and cause said memory analyzer to operate on said random access memory.

12. The system of claim 11, said memory monitoring agent further configured to identify a changed memory area within said random access memory and cause said memory analyzer to operate on said changed object.

13. The system of claim 9 further comprising:
an alerting system configured to create an alert based said vulnerability statistic.

14. The system of claim 9, said memory analyzer being configured to determine said vulnerability factor by analyzing a length of a sequence of NOP instructions.

15. The system of claim 14, said NOP instructions being any instructions that are not executed by an operating system kernel.

16. The system of claim 9, said memory analyzer being configured to determine said vulnerability factor by a method comprising:
creating a control flow graph for said object to identify a first plurality of blocks of consecutive instructions;
identifying a destination for said block from said control flow graph;
identifying a second plurality of said blocks that, if executed, connect to said destination;
for each of said second plurality of said blocks, identifying a length of instructions between said destination and a non-NOP command; and
aggregating said length of instructions to create a surface area metric for said destination.

17. A method comprising:
monitoring a random access memory using a first processor to identify changes to said random access memory;
for each of said changes to said random access memory, identifying an object affected by said changes and performing a simulated execution to determine at least a maximum length of NOP instructions that lead to a destination within said random access memory; and
creating a vulnerability statistic comprising a ratio of said maximum length of NOP instructions to a size of said random access memory, said maximum length being determined by a method comprising:
creating a control flow graph for said object to identify a first plurality of blocks of consecutive instructions;
identifying a destination for said object from said control flow graph;
identifying a second plurality of said blocks that, if executed, connect to said destination;
for each of said second plurality of said blocks, identifying a length of instructions between said destination and a non-NOP command; and
summing said length of instructions to create a surface area metric for said destination.

18. The method of claim 17, said NOP instructions being any instructions that do not include instructions executed by an operating system kernel.

19. The method of claim 17, said random access memory being a memory heap.

20. The method of claim 19, said method being applied to a sample of said changes to said random access memory.
